(19) United States
(12) Patent Application Publication
(10) Pub. No.: US 2009/0286527 A1
(43) Pub. Date: Nov. 19, 2009

(54) Apparatus and a method for service continuity between umts network and wlan network

(76) Inventors: Kyung-Yul Cheon, Daejeon (KR); Kwang-Hyun Ro, Daejeon (KR); Jae-Wook Shin, Daejeon (KR); Hye-Yeon Kwon, Daejeon (KR); Hyung-Cheol Shin, Daejeon (KR); Kwang-Ryul Jung, Daejeon (KR); You-Sun Hwang, Daejeon (KR); Ae-Soon Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 11/990,997

(22) PCT Filed: Aug. 24, 2006
(86) PCT No.: PCT/KR2006/003349

§ 371 Date: Feb. 26, 2008

(30) Foreign Application Priority Data
Aug. 26, 2005 (KR) 10-2005-0078824
Aug. 23, 2006 (KR) 10-2006-0080075

(51) Int. Cl. H04W 4/00

(52) U.S. Cl. 455/422.1

(57) ABSTRACT

Service continuity is provided between a 3GPP network and a non-3GPP network. When a mobile station having accepted service in the 3GPP network moves to the non-3GPP network or returns from the non-3GPP network to the 3GPP network, an interworking gateway is interworked with a GGSN through a universal tunnel using a packet data network, and accordingly a mobile subscriber may accept seamless service.

### BACKGROUND OF THE INVENTION

(a) Field of the Invention

The present invention relates to a service continuity apparatus and method for providing a seamless service between a universal mobile communication system network and wireless local area network. More particularly, the present invention relates to a service continuity apparatus and method for performing a handover without breaking a service between a 3GPP network and non-3GPP network.

(b) Description of the Related Art

A universal mobile telecommunication system (hereinafter, referred to as ‘UMTS’) presently includes a third generation mobile telecommunication system developed by a framework known as an international mobile communication standard-2000 (IMT-2000).

The third generation mobile communication system had been designed to provide multimedia communication. It has a high data speed so that it can increase public and private network information access and service and provide flexible telecommunication. Such a third generation mobile communication system has been studied regarding standard technologies by a 3rd Generation Partnership Project (3GPP) by standardization institutions or enterprises of many countries. Hereinafter, a system or network provided by the 3GPP, that is, the standardization institutions, is referred to as “3GPP system” or “3GPP network”. In addition, a system (e.g., wireless local area network) or network not provided by the 3GPP, that is, the standardization institutions, for example, is referred to as “non-3GPP system” or “non-3GPP network”.

The UMTS has a drawback in that a spectrum is largely consumed and data rate is low in comparison with the wireless local area network (hereinafter, referred to as ‘WLAN’). Accordingly, a system and method for utilizing WLAN bands is required so as to supplement a bandwidth of UMTS and improve efficiency thereof.

A conventional release 6-based 3GPP UMTS has provided an inter-network loaming structure for utilizing the WLAN in the 3GPP UMTS network and non-3GPP network. That is, it is described for a 3GPP subscriber to accept services such as 3GPP network authentication, authorization, and charging, and then to accept service of the 3GPP when the 3GPP subscriber accesses to the WLAN. Accordingly, a mobile station may accept a packet service though the 3GPP network even when it accesses the WLAN.

However, according to such a conventional structure, when the mobile station having accessed the 3GPP network moves in the WLAN while accepting a service or otherwise, the mobile station cannot use a previously-used address in a moved network. That is, since the mobile station must accept a new address from a gateway GPRS support node (GGSN) or a packet data gateway (PDG) of a newly moved network when it moves between networks, the mobile station cannot accept seamless service.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a service continuity apparatus and method having advantages of supporting a seamless service when a mobile station moves between a well known 3GPP UMTS network and a non-3GPP network.

An exemplary embodiment of the present invention provides a service continuity apparatus for supporting service continuity between a universal mobile communication system network and a wireless local area network. The service continuity apparatus includes a first node for transmitting a data packet to a mobile station in the universal mobile communication system network; a second node for performing a wireless gate function between the first node and the packet data network and allocating a first address to the mobile station through the first node so as to communicate data with the packet data network; and an interworking gateway for generating tunneling with the second network through the packet data network and providing a seamless service to the mobile station using the first address when the mobile station moves from the universal mobile communication system network to the wireless local area network.

At this time, the interworking gateway generates tunneling with the second node through the packet data network and provides a seamless service to the mobile station using the first address when the mobile station returns from the wireless local area network to the universal mobile communication system network.

Another embodiment of the present invention provides a service continuity method for supporting service continuity between a universal mobile communication system network and a wireless local area network. The service continuity includes (a) a first node performing a wireless gate function of an inter-packet data network by allocating a first address for communicating data with the packet data network to the mobile station accessed to the universal mobile communication system network and recoding the allocated first address on an authentication server;

(b) an interworking gateway receiving a tunnel establishment request message from the mobile station moved from the universal mobile communication system network to the wireless local area network;

(c) the interworking gateway performing user authentication and authorization and receiving the recoded first address from the authentication server by being interworked with the authentication server;

(d) the interworking gateway generating tunneling with the first node through the packet data network; and

(e) the interworking gateway transmitting a tunnel establishment response message including the received first address to the mobile station.

In addition, yet another embodiment of the present invention provides (a) a first node for transmitting a packet in a service area of the universal mobile communication system network receiving a PDP context activation request message from a mobile station, the mobile station having returned from the wireless local area network to the universal mobile communication system network;

(b) the first node transmitting a PDP context generation request message to a second node, the second node for performing a wireless gate to a node packet data network;

(c) the second node receiving a PDP address from an authentication server the PDP address being previously allocated to the mobile station accessed to the universal mobile communication system network so as to perform a data communication with the packet data network;

(d) the second node generating tunneling to an interworking gateway through the packet data network; and

(e) the first node transmitting a PDP context activation response message to the mobile station using the received PDP address.

### BRIEF DESCRIPTION OF THE DRAWINGS

FIG. 1 is a schematic diagram of an interworking system between a 3GPP network and a non-3GPP network for supporting a seamless service according to an exemplary embodiment of the present invention.

FIG. 2 is a flowchart for showing how a mobile station moves from a 3GPP network to a non-3GPP network according to an exemplary embodiment of the present invention.

FIG. 3 is a flowchart for showing how a mobile station moves from a non-3GPP network to a 3GPP network according to an exemplary embodiment of the present invention.

FIG. 4 is a schematic diagram of an interworking system between a 3GPP network and a non-3GPP network for supporting a seamless service according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. When it is described that an element is coupled to another element, the element may be directly coupled to the other element or coupled to the other element through a third element.

In addition, composition elements shown in the drawings may be implemented by hardware, software, or a combination thereof, and may be realized by at least one programmed universal device including a processor, a memory, and input/output interfaces.

Now a service continuity apparatus and method for supporting service continuity between a 3GPP network and a non-3GPP network according to an exemplary embodiment of the present invention will be described.

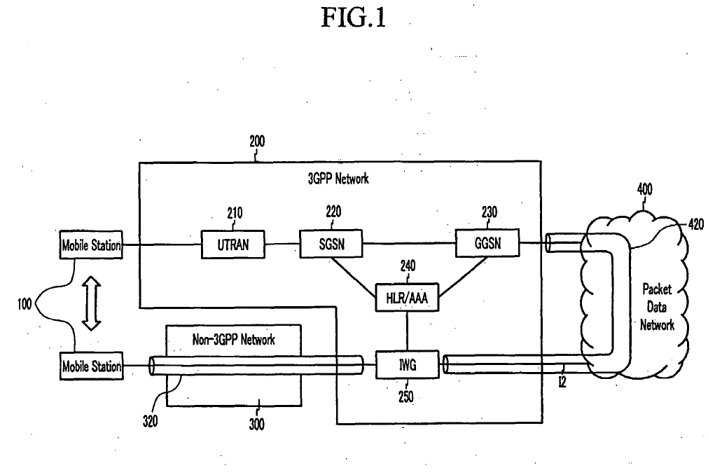

FIG. 1 is a schematic diagram of an interworking system between a 3GPP network and a non-3GPP network for supporting a seamless service according to an exemplary embodiment of the present invention. The system shown in FIG. 1 is one example. Accordingly, respective elements known to a person of ordinary skill in the art may be described briefly to impart understanding of an exemplary embodiment of the present invention.

In FIG. 1, a mobile station 100 is defined as a general mobile terminal having a dual mode of 3GPP and non-3GPP. A 3GPP network 200 is defined as a general universal mobile communication system (UMTS) network, and a non-3GPP network 300 is defined as all the wireless local area networks excluding the 3GPP network. For example, the non-3GPP network 300 includes the IEEE 602.16, Hyper LAN, Wibro, and Personal Area Network (PAN).

As shown in FIG. 1, the 3GPP network 200 includes a UTRAN 210, a SGSN 220, a GGSN 230, an HLR/AAA 240, and an interworking gateway 250.

The URRAN UMTS (Terrestrial Radio Access Network) 210 is a wireless access network for performing a wireless-related function, and includes a node B (not shown) and a wireless network controller (RNC) (not shown).

The SGSN (Serving GPRS Support Node: 220) is a node for performing a data packet transmission to the mobile station in a service area, and has packet routing and transmission, mobility management, local link management functions. In addition, the SGSN 220 includes a location register for storing user location information (cell, visitor location register, and the like) and user profile, in which the user is registered in the SGSN.

The GGSN (Gateway GPRS Support Node: 230) performs a wireless gateway function between the SGSN 220 and the packet data network (PDN). That is, the GGSN 230 transmits all the data to the packet data network, in which the data is transmitted/received in the packet data network. At this time, the GGSN 230 allocates a Packet Data Protocol (PDP) address through the SGSN 220 to the mobile station 100 such that the mobile station 100 may perform data communication with the packet data network. An HLR/AAA 240 stores the PDP address allocated by the GGSN 230.

The HLR/AAA 240 stores a home location of the mobile station 100 and the PDP address allocated by the GGSN 230, and performs an authentication to the mobile station.

An interworking gateway (hereinafter referred to as ‘IWG’) 250 is for performing a seamless service between the 3GPP network and the non-3GPP network, and is connected to the GGSN 230 through a universal tunnel 420 passing through the packet data network 400.

According to an exemplary embodiment of the present invention, when the mobile station 100 moves from the 3GPP network to the non-3GPP network, GGSN 230, the IWG 250 receives the PDP address previously allocated by the GGSN 230 from the HLR/AAA 240 and forms a tunnel 320 to the mobile station 100 by providing the received PDP address to the mobile station 100.

In FIG. 1, the packet data network 400 may be defined as a packet-based network including both of the Internet and intranet, and the GGSN 230 and IWG 250 according to an exemplary embodiment of the present invention respectively includes interfaces I1 and I2 for interworking with the packet data network 400.

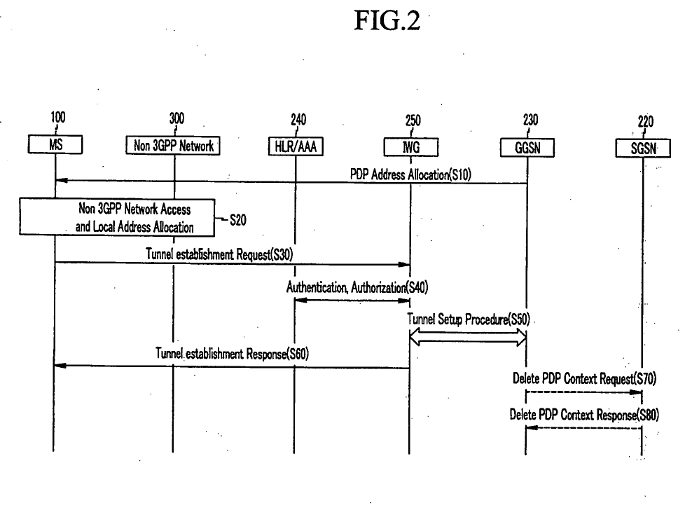

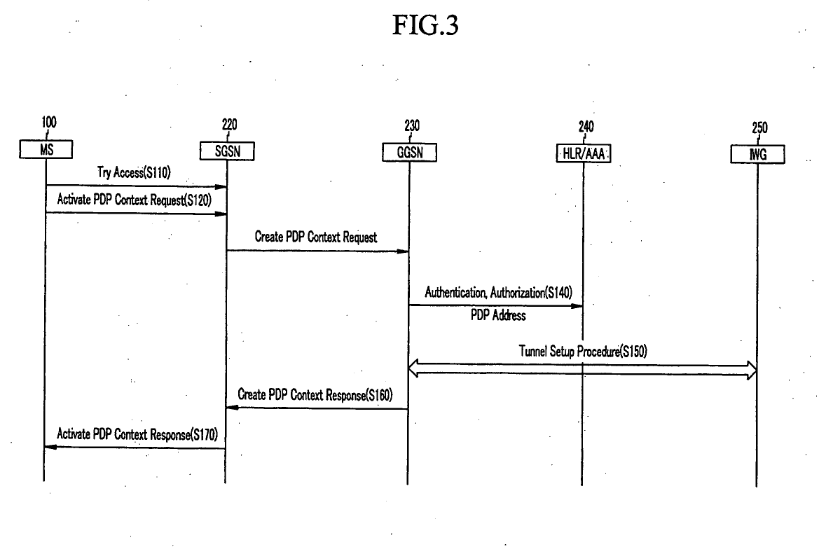

Now, how to interwork a service between the 3GPP network and the non-3GPP network is described with reference to FIG. 2 and FIG. 3.

FIG. 2 is a flowchart for showing how a mobile station moves from a 3GPP network to a non-3GPP network according to an exemplary embodiment of the present invention.

First, when the mobile station 100 of the 3GPP subscriber accesses the 3GPP network 200, the GGSN 230 allocates a PDP address to the mobile station (S10). At this time, the PDP address allocated by the GGSN 230 is stored at the HLR/AAA 240.

When the mobile station 100 accesses the non-3GPP network 300, the non-3GPP network 300 allocates a local address to the mobile station 100, in which the local address is for communicating data with the non-3GPP network 300 (S20).

The mobile station 100 then transmits a tunnel establishment request message to the IWG 250 (S30). When the IWG 250 receives the tunnel establishment request message from the mobile station 100, it performs user authentication and authorization by being interworked with the HLR/AAA 240 (S40) and then receives the previously-allocated PDP address from the HLR/AAA 240.

When the IWG 250 receives the PDP address, it cooperates with the GGSN 230 and establishes the tunnel 420 passing through the packet data network 400 (S50). At this time, so as to establish a security-ensured tunnel, it obtains tunnel establishment information from the HLR/AAA 240.

After the IWG 250 has established a tunnel by cooperating with the GGSN 230, the IWG 250 transmits a tunnel establishment response message including the PDP address obtained from the HLR/AAA 240 to the mobile station 100, and accordingly generates a tunnel 320 to the mobile station 100.

The GGSN 230 performs mobile station-link packet buffering as soon as it receives the tunnel establishment request message from the IWG 250, and transmits the buffered packet to the mobile station when the tunnel establishment is finished, and “the mobile station-link packet” is referred to as a packet transmitted to the mobile station herein.

The mobile station 100 may accept a seamless service with respect to all packet data transmitted to the 3GPP network using the generated tunnel 320 by means of the GGSN 230 and IWG 250.

In addition, the GGSN 230 may recycle radio resources by canceling a previously formed GRPS session using the same. That is, the GGSN 230 transmits the PDP context delete request message to the SGSN 220 so as to cancel the GRPS session (S70) and the SGSN 220 transmits the PDP context delete response message to the GGSN 230 (S80), and accordingly the given GRPS session is cancelled and the radio resource is recycled At this time, if the PDP context delete request message is not used, the SGSN 220 may cancel the given session by operating a timer (Mobile Reachable Timer) after a predetermined time.

FIG. 3 is a flowchart for showing how a mobile station moves from a non-3GPP network to a 3GPP network according to an exemplary embodiment of the present invention.

As described with reference to FIG. 2, when the mobile station 100 subscribed in the 3GPP network accesses the non-3GPP network 300, the mobile station 100 receives a local address allocated by the non-3GPP network 300 and the PDP address previously allocated from the IWG 250.

When the mobile station 100 returns to the 3GPP network, the mobile station 100 starts an access to the SGSG 220 (S110) and the mobile station 100 transmits a PDP context activation request message to the SGSN 220 (S120).

The SGSN 220 transmits a PDP context generation request message to the GGSN 230 (S130), and the GGSN 230 performs user authentication and authorization by being interworked with the HLR/AAA 240 and then receives the PDP address previously allocated from the HLR/AAA 240 (S140).

When the GGSN 230 has received the PDP address, it establishes a tunnel 420 passing through the packet data network 400 by cooperating with the IWG (S150). So as to establish a security-ensured tunnel, the GGSN 230 obtains the tunnel establishment information from the HLR/AAA 240.

The GGSN 230 then transmits a PDP context generation response message including the PDP address to the SGSN 220 (S160) and the SSGN 220 transmits a PDP context activation response message including the PDP address to the mobile station 100 (S170).

Though these steps, the mobile station 100 may accept a seamless service even if it moves from the non-3GPP network 200 to the 3GPP network.

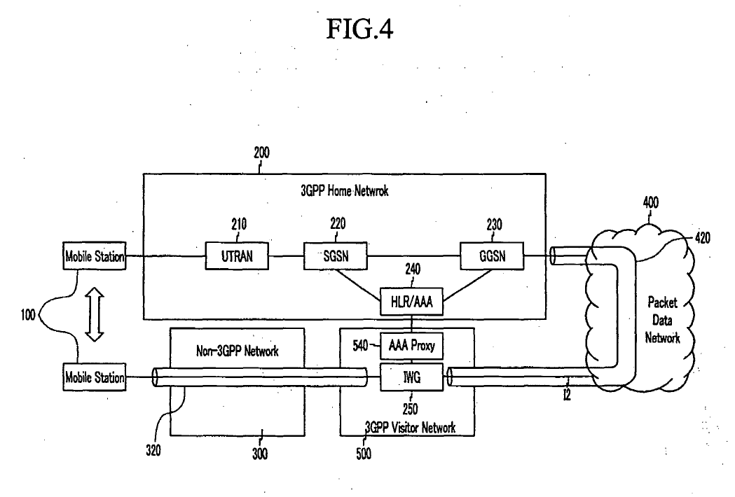

According to the first exemplary embodiment of the present invention as shown in FIG. 1, the IWG 250 is disposed in a 3GPP home network. However, the IWG 250 may be disposed in a 3GPP visitor network 500 as shown in FIG. 4. Elements in FIG. 4 that are the same or similar to those illustrated in FIG. 1 have the same or similar reference numerals. These elements may not be described for brevity of description.

As shown in FIG. 4, the 3GPP visitor network 500 additionally includes an AAA proxy 540 when the IWG 250 is disposed in the 3GPP visitor network 500. The AAA proxy 540 performs user authentication and authorization by interworking the IWG 250 with the HLR/AAA 240 of the 3GPP home network, receives the PDP address from the HLR/AAA 240, and transmits the same to the IWG 250.

As described above, according to an exemplary embodiment of the present invention, when the mobile station moves from the 3GPP network to the non-3GPP network or it returns from the non-3GPP network to the 3GPP network, it may accept a seamless service by generating a universal tunnel passing through the packet data network by means of the interworking gateway and the GGSN.

The recording medium may include all types of recording media that a computer can read, for example an HDD, a memory, a CD-ROM, a magnetic tape, and a floppy disk, and it may also be realized in a carrier wave (e.g., Internet communication) format.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to an exemplary embodiment of the present invention, the mobile station may accept a seamless service even if it moves between the 3GPP network and the non-3GPP network.

1. A service continuity apparatus for supporting service continuity between a universal mobile communication system network and a wireless local area network, the service continuity apparatus comprising:
a first node for transmitting a data packet to a mobile station in a service area of the universal mobile communication system network;
a second node for performing a wireless gate function between the first node and the packet data network and allocating a first address to the mobile station through the first node so as to communicate data with the packet data network; and
an interworking gateway for generating tunneling with the second network through the packet data network and providing a seamless service to the mobile station using the first address when the mobile station moves from the universal mobile communication system network to the wireless local area network.

2. The service continuity apparatus of claim 1, wherein the interworking gateway forms a tunnel with the mobile station using the first address.

3. The service continuity apparatus of claim 1, wherein the interworking gateway generates tunneling with the second node through the packet data network and provides a seamless service to the mobile station using the first address when the mobile station returns from the wireless local area network to the universal mobile communication system network.

4. The service continuity apparatus of claim 1, wherein the first node is given as an SGSN (Serving GPRS Support Node), and the second node is given as a GGSN (Gateway GPRS Support Node).

5. The service continuity apparatus of claim 4, wherein the first address is a PDP (Packet Data Protocol) address.

6. The service continuity apparatus of claim 5, wherein the interworking gateway includes an interface for interworking with the packet data network.

7. The service continuity apparatus of claim 4, wherein the interworking gateway receives the first address allocated by the second node from an authentication server.

8. The service continuity apparatus of claim 7, wherein the interworking gateway is disposed in a visitor network of the universal mobile communication system network, and the visitor network of the universal mobile communication system includes a proxy authentication server for performing user authentication and authorization by being interworked with the authentication server.

9. A service continuity method for supporting service continuity between a universal mobile communication system network and a wireless local area network, the service continuity method comprising:
a first node performing a wireless gate function of an inter-packet data network allocating a first address for communicating data with the packet data network to the mobile station accessed to the universal mobile communication system network, and recording the allocated first address on an authentication server;
an interworking gateway receiving a tunnel establishment request message from the mobile station having moved from the universal mobile communication system network to the wireless local area network;
the interworking gateway performing a user authentication and authorization and receiving the recorded first address from the authentication server by being interworked with the authentication server;
the interworking gateway generating a tunneling with the first node through the packet data network; and
the interworking gateway transmitting a tunnel establishment response message including the received first address to the mobile station.

10. The service continuity method of claim 9, further comprising:
the first node transmitting a PDP context delete request message to a second node the second node being for transmitting a data packet to the mobile station in a service area of the universal mobile communication system network; and
the second node canceling a session by transmitting a PDP context delete response message to the first node.

11. The service continuity method of claim 9, wherein the first node is given as a GGSN (Gateway GPRS Support Node).

12. The service continuity method of claim 11, wherein the first address is given as a PDP (Packet Data Protocol) address.

13. A service continuity method for supporting service continuity between a universal mobile communication system network and a wireless local area network, the service continuity method comprising:
a first node for transmitting a packet in a service area of the universal mobile communication system network receiving a PDP context activation request message from a mobile station, the mobile station having returned from the wireless local area network to the universal mobile communication system network;
the first node transmitting a PDP context generation request message to a second node, the second node for performing a wireless gate function to a node packet data network;
the second node receiving a PDP address from an authentication server, the PDP address being previously allocated to the mobile station accessed to the universal mobile communication system network so as to perform data communication with the packet data network;
the second node generating tunneling to an interworking gateway through the packet data network; and
the first node transmitting a PDP context activation response message to the mobile station using the received PDP address.

14. The service continuity method of claim 13, wherein the first node is given as an SGSN (Serving GPRS Support Node), and the second node is given as a GGSN (Gateway GPRS Support Node).

15. The service continuity method of claim 10, wherein the first node is given as a GGSN (Gateway GPRS Support Node).
